(19) United States
(12) Patent Application Publication
(10) Pub. No.: US 2024/0367122 A1
(43) Pub. Date: Nov. 7, 2024

(54) HOLLOW SHAFT IMPELLER

(71) Applicant: EMD Millipore Corporation, Burlington, MA (US)

(72) Inventors: Sualyneth Galarza, Brighton, MA (US); Anne Hansen, North Reading, MA (US); Amy Mei, Medford, MA (US); Amy Wood, Concord, MA (US); James J. Vigna, Tyngsborough, MA (US); Marisa Maher, Somerville, MA (US)

(21) Appl. No.: 18/687,944

(22) PCT Filed: Nov. 16, 2022
(86) PCT No.: PCT/US2022/079926

§ 371 Date: Feb. 29, 2024

Related U.S. Application Data
(60) Provisional application No. 63/292,445, filed on Dec. 22, 2021.

(51) Int. Cl. B01F 27/2122; B01F 27/17; B01F 33/453

(52) U.S. Cl. CPC B01F 27/2122; B01F 27/17; B01F 33/453

(57) ABSTRACT

A hollow shaft impeller (100) having a hollow impeller housing (120), a magnet (108), an impeller cap (102), an impeller retainer (106), and a plurality of impeller blades (134). The impeller housing has a hub (130) that defines an interior volume (128) and an impeller bore that provides access to the interior volume. The magnet may be sized to be disposed within the interior volume. The impeller cap may be removably coupled to the hollow impeller housing proximate to the impeller bore. The impeller retainer may be removably coupled to the magnet and sized to be disposed within the interior volume. The plurality of impeller blades may project from the hub. Optionally, fins (140) may be disposed on each of the plurality of impeller blades.

### CROSS-REFERENCE TO RELATED APPLICATIONS

This present application claims priority to U.S. Provisional Patent Application Ser. No. 63/292,445, entitled “HOLLOW SHAFT IMPELLER,” and filed on Dec. 22, 2021, the disclosure of which is incorporated herein by reference in its entirety for all purposes.

### TECHNICAL FIELD

This application relates to bioprocessing containers, such as storage tanks, bioreactors, and other vessels. In particular, embodiments of the technologies disclosed herein relate to mixers useful in bioprocessing containers.

### BACKGROUND OF THE INVENTION

Biological fluids comprising cells and other viral vectors are manufactured within bioreactors and other vessels in the pharmaceutical and biopharmaceutical industries. Previous bioreactors were rigid stainless steel or glass having highly controlled processing parameters including pH, oxygen and carbon dioxide concentration, turbidity, and temperature, which were monitored and controlled by permanent sensors built into the rigid bioreactors. During bioprocessing, e.g., cell growth within the biological fluid in the bioreactor, uniform distribution of temperature, gases, and nutrients was maintained by mixing. A suitable mixing system provides three functions: the creation of a stable environment (nutrients, pH, temperature, etc.) in a homogeneous distribution, the dispersion of gases (i.e., supplying O₂ and extracting CO₂), and the optimization of the heat transfer. Many components are mixed into biological fluids, such as buffers, adjuvants, oxygen, cell culture media, and the like. Providing acceptable mixing, without imparting damaging shear effects, becomes more challenging as the scale of the bioreactor container increases. The inclusion of a well-designed impeller allows for better mixing efficiency without the risk of high shear associated with high impeller speeds.

Mixing systems typically comprise an impeller having a shaft, and blades projecting from the shaft, connected to a motor located outside the bioreactor. Multiple use stainless steel reactors require intensive cleaning and sterilization before re-use. The impeller, spargers, and sensors (e.g., gas, temperature and pH sensors) are also multi-use components, requiring sterilization after each batch process. More recent developments in bioprocessing introduced the advent of single-use bioreactors, which may provide greater flexibility in manufacturing and reduce the time needed to affect a valid regeneration or sterilization of the equipment. Processors have begun to utilize disposable sterilized containers such as bags that are used once and disposed, also using a shaft connected with a motor, typically top-loaded. Single-use bioreactors employ disposable bags comprised of thin, flexible polymeric films. Pre-sterilized, single-use bags, including components (e.g., single-use sensors and impellers), eliminate the need for cleaning, sterilization, and validation. Accordingly, their use results in substantial savings in manufacturing and maintenance costs. A bioprocessing challenge associated with single-use bags and components is the positioning of the components within a flexible bioreactor post-sterilization. Following sterilization, flexible bioreactors are stored and shipped. Unlike a rigid, stainless-steel vessel, a bioreactor bag has no structural rigidity and is subject to abrasion and tearing.

Generally, bioreactor components like impeller shafts, spargers, and sensors were attached inside the rigid vessel by threaded posts, bolts, clamps and/or other joining methods having seals and bearings. These methods were not suitable for flexible bioreactor bags as they would result in damage to the flexible bioreactor bags, leaking, contamination, and other failure modes both before and during processing.

Homogeneous mixing is important. However, thorough mixing may damage cells by introducing high amounts of shear. Many mixing operations are carried out in bioreactors having a mixing impeller mounted near a bottom of the vessel. A variety of impellers having differently sized and shaped impeller hubs, impeller blades, and shafts were necessary for mixing within many differently sized and shaped bioreactors. Past prior art bioprocessing included agitator tanks and systems to complete the mixing process. Such systems achieved mixing by using a mechanical stirrer that was lowered into the biological fluid through an opening in the top of the vessel and rotated by an external motor to create the desired mixing action. Such systems were also inefficient and required additional motors and components.

Attempts to solve these problems consist of systems for mixing biological fluids using a rotating magnetic impeller that was magnetically coupled with a shaft and conducting element. The magnetic impeller was placed in a vessel and positioned adjacent a conducting element. The vessel was sealed with the magnetic impeller therein, wherein the biological fluid was delivered after sealing. However, limitations remaining from this approach are that only magnetic interactions provide “support” of the magnetic impeller. These systems controlled vertical levitation of impellers but suffer from poor lateral control. Particularly at higher speeds, the levitating impellers wobble, which results in damage to the single-use bioreactors. External bearing rings were next used to laterally stabilize magnetic impellers, which did not work well, were heavy, and required a large amount of torque. Microprocessors utilizing feedback control are also necessary to stabilize the bearing ring-style impellers, which are expensive. Some past impellers attempted to solve these processing issues by providing a flow path through the shaft, which wobbled and also failed to withstand turbulence.

Providing an improved mixing system for single-use containers or bioreactors for biological fluid processing having a novel impeller that overcomes previous drawbacks to achieve homogeneous mixing necessary for optimal cell culture growth represents an advance in the art. Substantial gains in efficiency, shorter mixing times, lessened power usage and higher power delivered, lessened shear and impeller wobble, and ease of use are now realized and significantly expand the potential applications for which advanced mixing systems may be used. Also, the novel and inventive embodiments described herein are useful for vessels, containers, and/or bioreactors capable of holding fluid volumes greater than 10 liters. In some embodiments, the fluid volumes are from 10 L to 50 L. In some further embodiments, the fluid volumes are from 40 L to 200 L. In some even further embodiments, the fluid volumes are from 100 L to 500 L. In some additional embodiments, the fluid volumes are from 200 L to 1000 L. Moreover, in some embodiments, the fluid volumes are from 400 L to 2000 L. It is to be understood that a container or bioreactor capable of holding, for example, 50 L might sometimes process significantly less fluid, for example, 10 L.

### SUMMARY OF THE INVENTION

Impellers are disclosed, which may include an impeller cap, an optional gasket, an impeller retainer, and a circular magnet, all of which may be at least partially housed within a hollow impeller housing. The hollow impeller housing may include an impeller bore and a hub. The circular magnet may include a bore, and may be placed within the impeller bore. The impeller cap may mate with an optional gasket or O-ring, and may be at least partially disposed within the impeller bore along with the impeller retainer. The impeller may further include plurality of impeller blades, wherein the plurality of impeller blades may project from the hub as shown in and/or described in connection with at least one of the figures. Novel and inventive features of the present disclosure, as well as details of exemplary embodiments thereof, will be more fully understood from the following description and drawings.

In at least one embodiment, a hollow shaft impeller includes a hollow impeller housing, a magnet, an impeller cap, an impeller retainer, and a plurality of impeller blades. The hollow impeller housing may have a hub that defines an interior volume and an impeller bore that provides access to the interior volume. The magnet may be sized to be disposed within the interior volume. In addition, the impeller cap may be removably coupled to the hollow impeller housing proximate to the impeller bore. The impeller retainer may be removably coupled to the magnet and may be sized such that it may be disposed within the interior volume. The plurality of impeller blades may project from the hub of the hollow impeller housing.

In some instances, the plurality of impeller blades include three, four, five, or more impeller blades. In some further instances, at least one fin may be disposed on each impeller blade of the plurality of impeller blades, where the at least one fin may be triangular shaped. In some even further instances, the at least one fin may be disposed on each impeller blade of the plurality of impeller blades between a top edge and a bottom edge of each impeller blade of the plurality of impeller blades. The at least one fin may be disposed on, and extend from, a blade face of each impeller blade of the plurality of impeller blades.

In yet some further instances, the hollow shaft impeller further includes a gasket coupled to the impeller cap. The gasket may be configured to seal, along with the impeller cap, the interior volume at the impeller bore. In some additional instances, the gasket may be an O-ring. In some even further instances, the gasket comprises an elastomeric material such as, but not limited to, a vinyl material, a polyethylene material, a polypropylene material, a nylon material, a silicon material, a polytetrafluoroethylene material, or a rubber material.

In some other instances, the impeller retainer may include a circular flange that has a top surface, an opposite bottom surface, a boss projecting from the top surface of the circular flange, and a cylinder descending from the bottom surface of the circular flange. When the impeller retainer is disposed within the interior volume, the boss may be configured to interact with the impeller cap. The cylinder of the impeller retainer may include a plurality of rails disposed about an exterior surface of the cylinder. In some further instances, the magnet may include a bore centrally disposed on the magnet and a plurality of slots disposed around a perimeter of the bore. The cylinder and the plurality of rails may be keyed to the bore and the plurality of slots of the magnet such that the bore and the plurality of slots of the magnet are configured to at least partially receive the cylinder and the plurality of rails of the impeller retainer. In some additional instances, when the cylinder and the plurality of rails of the impeller retainer are disposed within the bore and the plurality of slots of the magnet, the magnet may be coupled to the impeller retainer.

In even some further instances, the impeller cap may include cap beams and cap slots disposed about the impeller cap. In addition, the impeller bore of the hollow shaft impeller may include hub beams and hub slots disposed about the impeller bore. The cap beams may be configured to be disposed within the hub slots and the hub beams may be configured to be disposed within the cap slots when the impeller cap is coupled to the hollow impeller housing.

These advances and others embodied herein will become clear from the description, claims, and figures below. Various benefits, aspects, novel and inventive features of the present disclosure, as well as details of exemplary embodiments thereof, will be more fully understood from the following description and drawings. The manner in which the features disclosed herein can be understood in detail (i.e., more particular descriptions of the embodiments of the disclosure briefly summarized above) may be had by reference to the appended drawings. It is to be noted, however, that the appended drawings illustrate only typical embodiments of this disclosure and are therefore not to be considered limiting of its scope. The described embodiments may admit to other equally effective bags, biocontainers, films, and/or materials. It is also to be understood that elements and features of one embodiment may be found in other embodiments without further recitation and that, where possible, identical reference numerals have been used to indicate comparable elements that are common to the figures. As used herein, the singular forms “a,” “an,” and “the” include plural referents unless the context clearly dictates otherwise. Unless defined otherwise, all technical and scientific terms used herein have the same meaning as commonly understood by one of ordinary skill in the art to which these embodiments pertain.

In this disclosure, reference is made to an integrated or unitary piece. For purposes herein, a unitary or integrated piece indicates a piece that cannot be disassembled without destroying the piece. For example, a hub having impeller arms that can be added or subtracted to the hub is not integral nor unitary. Conversely, a hub having impeller arms that cannot be added or subtracted to the hub is unitary and/or integrated. In some embodiments, an integrated or unitary piece is formed by a single manufacturing process, e.g., injection molding of the hub and impeller arms in a single injection molding cycle.

### BRIEF DESCRIPTIONS OF THE DRAWINGS

The apparatuses, systems, devices, and components presented herein may be better understood with reference to the following drawings and description. It should be understood that some elements in the figures may not necessarily be to scale and that emphasis has been placed upon illustrating the principles disclosed herein. In the figures, like-referenced numerals designate corresponding parts/steps throughout the different views.

FIG. 1 depicts an exploded side perspective view of a hollow shaft impeller, according to some embodiments of the disclosure;

FIG. 2 depicts a portion of a side view of a hub and an impeller blade having a fin, according to some embodiments of the disclosure;

FIG. 3 depicts a top perspective view of a cap for a hollow shaft impeller, according to some embodiments of the disclosure;

FIG. 4 depicts a top perspective view of a hollow shaft impeller, according to some embodiments of the disclosure; and

FIG. 5 depicts a side perspective view of a bioprocessing system comprising a single use bioreactor and a hollow shaft impeller having impeller blades further comprising fins, according to some embodiments of the disclosure.

FIG. 6 depicts a graph depicting a tilting parameter of an impeller at a tested rotational speed, according to some embodiments of the disclosure.

### DETAILED DESCRIPTION

Described herein are some embodiments of impellers, wherein the impellers can be used both with systems having direct connection with rotating drive shafts and magnetically-coupled, levitating hollow shaft impellers that comprise magnets. Embodiments of some impellers, according to the disclosure, comprise a hollow shaft. Embodiments of some impellers comprise a hollow shaft that further comprises a cap placed on the hollow shaft.

Embodiments of some impellers comprise a hollow shaft that further comprises a three-pitch blade or a four-pitch blade impeller. Embodiments of some impellers comprise a hollow shaft that further comprises a three-pitch blade or a four-pitch blade impeller having one or more fins on one or more blades. The hollow shaft may be sealed by a cap, which substantially prevents ingress of a liquid, wherein an air cavity equilibrates and/or stabilizes the impeller submerged in liquid without the additional weight of a solid shaft or the attendant wobble of a flow-through shaft. Also, additional weight requires additional torque, which leads to additional costs and unfavorably promotes impeller wobble. It is further believed that a hollow shaft(s) better distributes torque. In the case of a bottom mounted impeller, a hollow shaft designs reduce wobble and decrease mixing times. Moreover, the reduction of wobble helps protect a bag containing a hollow shaft impeller during processing. Many embodiments of hollow shaft impellers are contemplated within this disclosure.

For example, various sizes of blades on hollow shafts, various shapes of blades, various sizes of fins disposed on blades or on hollow shafts, and various locations of fins disposed on blades are disclosed herein. For example, embodiments of the disclosure comprise one or more fins on a shaft, one or more fins on top of a blade(s), one or more fins on a bottom of a blade(s), and/or one or more fins on a middle of a blade(s). Additional inventive features of some embodiments of the impeller(s) comprise a cap having a pin and hole design, and an internal cylinder in the hollow shaft for transfer of the torque, maintenance of stability, and keeping, for example, a motor magnet in place. Embodiments of hollow shafts disclosed herein are lighter in weight, have less material, have higher polar moments of inertia, have higher radii of gyration, and have higher torsional strength. Embodiments of the disclosure also exhibit shorter mixing times, higher power delivered, and significant decrease in wobble for an impeller used in 200 L to 2000 L and higher sized bioreactors. Embodiments of some hollow shaft impellers, wherein the impeller blades have fins that are located within approximately 10% of a center line of a width of the impeller blade exhibit little wobble and are not pushed down even at high revolutions per minute (RPM) (e.g., 100-120 RPM). A hollow shaft impeller having impeller blades that further comprise fins located within 10% of a center line of the width of the impeller blades exhibit so little wobble, even at high RPMs, that the impeller blades and/or fins do not hit a bottom of a bioreactor bag or biocontainer, as described more fully below.

The term biocontainer is defined as any reactor, container, or vessel capable of holding a fluid within an internal volume or region, and may be in the form of a two-dimensional, three-dimensional, and/or multi-faceted bag or bioreactor. In some embodiments, the biocontainer or bioreactor is flexible and has a baffle incorporated therein, wherein the baffle is capable of disrupting a vortex within a liquid formed when a mixer, such as an impeller, mixes the liquid. Also, some embodiments comprise a sparger for delivering and distributing gases into the bioreactor. The bioreactor or container may comprise a film. The term film within the meaning of this disclosure means any flexible material that is capable of being fused with another flexible film, including, but not limited to, polymeric sheet, composites, laminates, single-layer, and/or multi-layer polymeric materials. These films may further comprise substrates, which may comprise plastic netting, wovens, non-wovens, knits, and/or metallic foils and other flexible structures and materials. In some embodiments, the flexible films comprise a laminate film structure with a lower melting point material internal to an external higher melting point polymer. Also, in some embodiments, the flexible films comprise a laminate film structure with a lower melting point material surrounding a higher melting point woven, knit, or non-woven material. In some embodiments, any of the bottom film, middle film, or the top film comprise any of the films as described in WO2020101848A1, which is incorporated by reference in its entirety. In some embodiments, one or more of these films is/are substantially similar to a PUREFLEX®, PUREFLEX PLUS® or ULTIMUS® film as marketed by EMD Millipore Corporation, Burlington, MA, USA.

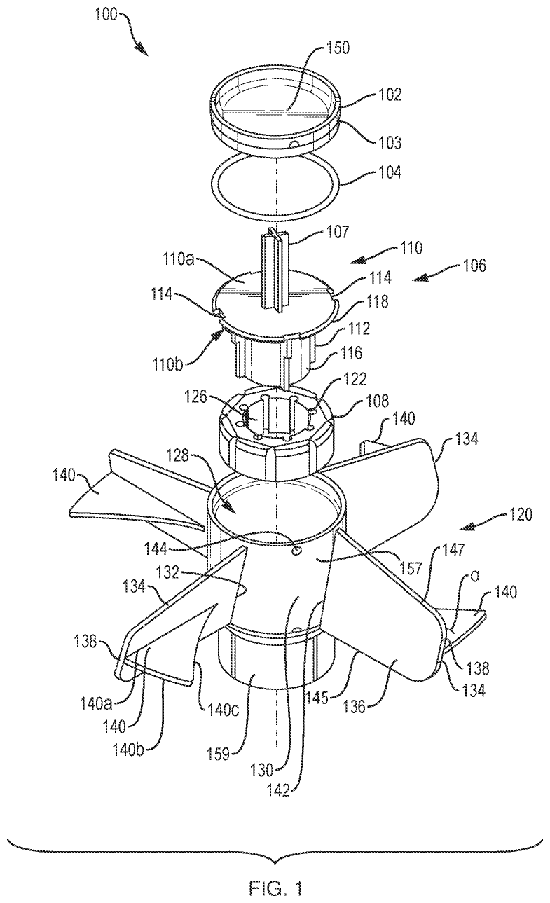

FIG. 1 depicts a side exploded perspective view of a hollow shaft impeller 100, according to some embodiments of the disclosure. The hollow shaft impeller 100 comprises an impeller cap 102 that mates with, optionally, a gasket 104. For example, the impeller cap 102 may comprise a groove 103 to house the gasket 104. In some embodiments, the gasket 104 is an O-ring. In some embodiments, the gasket 104 or O-ring is made of an elastomeric material, for example, a vinyl material, a polyethylene material, a polypropylene material, a nylon material, a silicon material, a polytetrafluoroethylene material, a rubber material, and/or other polymeric materials as is known to those in the art. An impeller retainer 106 comprises a circular flange 110 that contains a top circular surface 110a and an opposite bottom circular surface 110b. As illustrated, a boss 107 projects from the top circular surface 110a. The impeller retainer 106 further comprises a cylinder 116 descending or projecting from the bottom circular surface 110b. The cylinder 116 may include a plurality of rails 112 disposed around an exterior surface of the cylinder 116. The circular flange 110 further comprises cutouts 114, which interact with knobs on an inner portion of the hollow shaft impeller 100 (not shown in this view), and a centering member 118, which is formed on a perimeter of the circular flange 110. The plurality of rails 112 of the cylinder 116 are configured to key into a plurality of slots 122 formed around the perimeter of a bore 126 centrally disposed in a circular magnet 108. Thus, the bore 126 of the circular magnet 108 may be configured to at least partially receive the cylinder 116 of the impeller retainer 106, while the plurality of slots 122 are configured to at least partially receive the plurality of rails 112 of the cylinder 116. When the cylinder 116 and the plurality of rails 112 of the impeller retainer 106 are disposed within the bore 126 and the plurality of slots 122 of the magnet 108, the magnet 108 is removably coupled to the impeller retainer 106.

The hollow impeller housing 120 may further comprise a hub 130 that may define an interior volume 128 and an impeller bore that provides access to the interior volume 128. The impeller retainer 106 and the circular magnet 108 are sized and shaped to be disposed within the interior volume 128 such that the impeller retainer 106 and the circular magnet 108 are configured to be housed within a hollow impeller housing 120. The impeller cap 102 may be removably coupled to the hollow impeller housing 120 at the impeller bore, where the gasket 104 may be configured to form a seal proximate to the impeller bore to seal the interior volume 128.

In accordance with some embodiments disclosed herein, and as previously explained, the hollow impeller housing 120 may comprises a hub 130 that includes a top end, a bottom end, and at least first and second impeller arm slots 132 arranged substantially vertically and extending from the top end toward the bottom end. The impeller cap 102 may be placed on the top end of the hub 130 in order to seal an air cavity therein. Also, at least first and second impeller blades 134 extend from the hub 130 at the arm slots 132. As shown in the embodiment illustrated in FIG. 1, the hub 130 includes four arm slots 132 and four impeller blades 134. Each impeller blade 134 comprises a blade face 136. In addition, each impeller blade 134 may have an outer edge 138, an inner edge 142 opposite the outer edge 138, a bottom edge 145 spanning between the outer edge 138 and the inner edge 142, and a top edge 147 opposite the bottom edge 145 and also spanning between the outer edge 138 and the inner edge 142. The inner edge 142 of the impeller blade 134 may extend into a slot 132 where the inner edge 142 may be engaged in the slot 132. In some embodiments, the inner edge 142 of the impeller blade 134 may engage with another impeller blade. As explained in further detail below, each impeller blade 134 may further comprise a fin 140 disposed on, and projecting/extending from, the blade face 136.

It is contemplated herein that the impeller blades 134 and the hub 130 can be a single unitary piece, i.e., a plastic piece made via an injection molding process, wherein the plastic piece could not be dissembled without destruction. The fins 140 could later be attached to the impeller blades 134. For example, the fins 140 may be attached using screws, bolts, rivets, adhesives, cantilever beams, snap fits, and/or other attachment means known to those in the art. Alternatively, an impeller blade 134 and a fin 140 may be molded as a single unitary piece, and subsequently attached to the hub 130. As explained previously, the impeller blades 134 having the fins 140 molded as a single unitary piece may be attached using screws, bolts, rivets, adhesives, cantilever beams, snap fits, and/or other attachment means known to those in the art. In some embodiments, screws, bolts, rivets, adhesives, cantilever beams, snap fits, and/or other attachment means known to those in the art can be used to attach the impeller blade 134 to the hub 130 and the fin 140 to the impeller blade 134. Moreover, while the illustrated embodiment includes four blades 134, the hollow shaft impeller 100 may include any number of blades 134, including, but not limited to, three blades 134, four blades 134, five blades 134, etc.

In some embodiments, the fins 140 may each be substantially triangular shaped and having edges 140a, 140b, and 140c, where edge 140a is attached to the impeller blade 134. The edges 140a, 140b, and 140c can be linear or, alternatively, form a curved or parabolic function. As shown, the edge 140b of the fin 140 begins at a distance from the hub 130 and ends at an outer edge 138 of the impeller blade 134. It is further contemplated that the fin 140 need not extend to the outer edge 138. Furthermore, the fin 140 may extend closer or right up to a surface of the hub 130. It is further contemplated that the fin 140 may form a right angle α with the impeller blade 134 or form an angle α that is greater or lesser than 90°. For example, in some embodiments, the angle α is approximately 50-80°. In some exemplary embodiments, the angle α is 76° with respect to a clockwise axis of rotation when viewing the outer edge 138 of the impeller blade 134 and toward the hub 130.

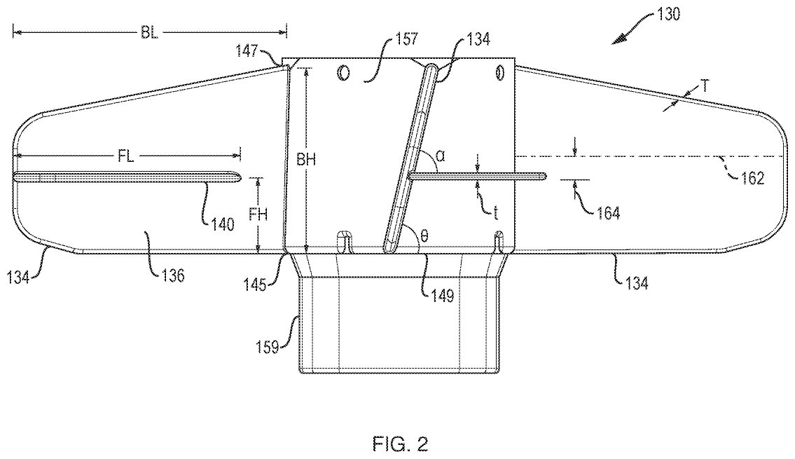

FIG. 2 depicts a portion of a side perspective view of a hub 130 and an impeller blade 134 having a fin 140, according to some embodiments of the disclosure. The impeller blade 134 has a height BH, a length BL, and a centerline 162. In addition, the fin 140 has a length FL and a height location FH along the height BH of the impeller blade 134. In some embodiments, the fin 140 is located approximately halfway between a bottom edge 145 and a top edge 147 of the impeller blade 134. As shown, the fin 140 is located approximately 40% along the impeller blade height BH from the bottom edge 145. In other embodiments, the fin 140 may be located approximately 60% along the impeller blade height BH from the bottom edge 145. In some embodiments, the height FH of the fin 140 along the impeller blade 134 may be between approximately 25% to 75% of the height BH of the impeller blade 134. The fin 140 may be located along the impeller blade height BH such that the fin 140 is disposed a distance 164 from the centerline 162 of the impeller blade 134. The outer diameter of the hub 130 may be between approximately 2 centimeters (cm) and 15 centimeters. In some embodiments, the outer diameter of the hub 130 may be approximately 10-11 cm. The length BL of the impeller blade 134 may be approximately 1 cm to 15 cm. In some embodiments, the hollow shaft impeller 100 comprises four impeller blades 134 that are disposed about the hub 130 such that the impeller blades 134 are spaced equidistant from each other. The overall diameter of the hollow shaft impeller 100 in some embodiments, is approximately 40-45 cm, wherein the outer diameter of the hub 130 is approximately 10-30 cm and each impeller blade 134, which are diametrically opposed, are each approximately 12 cm in length. In some exemplary embodiments, the outer diameter of the hub 130 is 12 cm.

The impeller blade 134 has a thickness T. In general, the thickness T is scalable for different impellers, for example, the thickness T may be approximately 0.20 to 0.5 cm. The fin 140 has a thickness t, which is generally lesser than the thickness T of the impeller blade 134, such as 0.15 to 0.4 cm. The fin 140 has a length FL that, in some embodiments, is 50% a length BL of the impeller blade 134. In other embodiments, the length FL may be 90% of the length BL of the impeller blade 134. As shown in FIG. 2, the length FL is approximately 90% of the length BL. It is to be understood that the length FL, if less than the length BL, can start at a point proximal to the hub 130 or distal from the hub 130. In some exemplary embodiments, the length BL may be approximately 60%-80% of the length BL of the impeller blade 134. The impeller blade 134 may be oriented on the hub 130 such that the impeller blade 134 is at an angle ⊖ from a bottom edge 149 of the hub 130. In some exemplary embodiments, the angle ⊖ may be between 60-80°. In some exemplary embodiments, the angle ⊖ may be 76°.

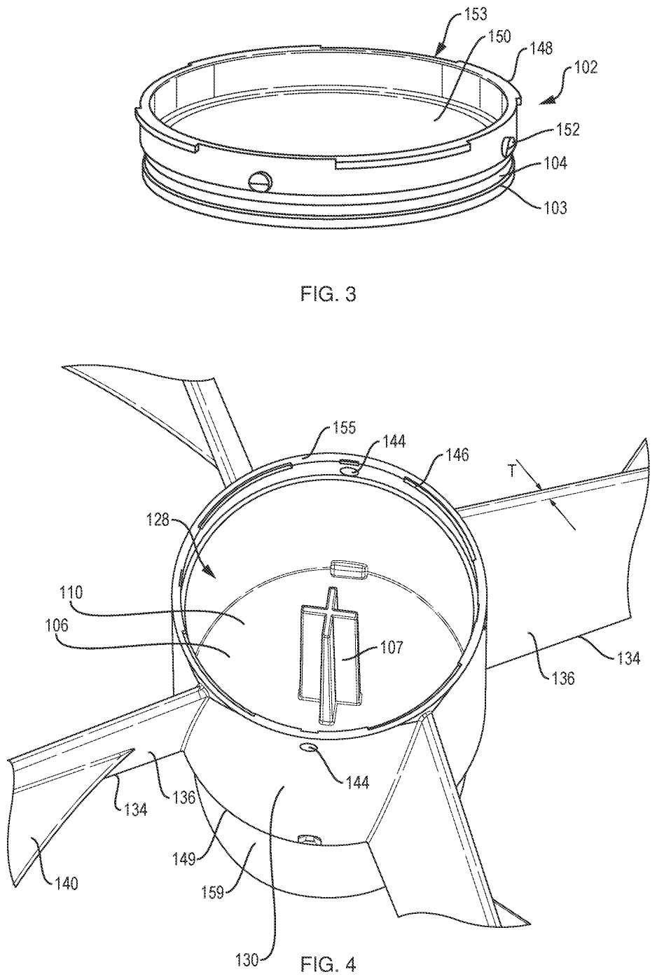

FIG. 3 depicts a top perspective view of an impeller cap 102 for a hollow shaft impeller 100, according to some embodiments of the disclosure. The impeller cap 102 has a surface 150 for sealing the hollow shaft impeller 100 from fluids during use. The impeller cap 102 also comprises a groove 103 to house a gasket 104. The impeller cap 102 optionally comprises studs 152 for locking the impeller cap 102 within the holes 144 of the hub 130 (best shown in FIG. 4). The impeller cap 102 may further comprise cap beams 148 and cap slots 153 for locking with corresponding hub beams 155 and hub slots 146 (best shown in FIG. 4). More specifically, the cap beams 148 may be configured to be disposed within the hub slots 146 and the hub beams 155 may be configured to be disposed within the cap slots 153 when the impeller cap 102 is removably coupled to the hollow impeller housing 120.

FIG. 4 depicts a top perspective view of a portion the hub 130 for a hollow shaft impeller 100, according to some embodiments of the disclosure. The hub 130 comprises an upper part 157 having an interior volume 128 (as described above with reference to FIG. 1) and a lower part 159. The upper part 157 of the hub 130 meets the lower part 159 of the hub 130 at bottom edge 149. As shown, the impeller retainer 106, comprising the boss 107, is placed inside of the interior volume 128 of the hub 130. While not illustrated, the circular magnet 108, discussed above and illustrated in FIG. 1, is kept in place within the interior volume 128 of the hub 130 by the impeller retainer 106. As previously explained, the circular magnet 108 is configured to be keyed to the cylinder 116 projecting from the bottom circular surface 110b of the circular flange 110. Thus, when disposed within the interior volume 128 of the hub 130, the circular magnet 108 is disposed below the circular flange 110 of the impeller retainer 106. The boss 107 of the impeller retainer 106 is configured to interact with the surface 150 of the impeller cap 102 to retain both the impeller retainer 106 and the circular magnet 108 disposed below the circular flange 110 of the impeller retainer 106 within the interior volume 128 of the hub 130 when the impeller cap 102 is coupled to the hub 130. This arrangement prevents the circular magnet 108 from moving up and down within the hollow shaft impeller 100. The circular flange 110 of the impeller retainer 106 further serves to center the circular magnet 108 in the interior volume 128 of the hub 130.

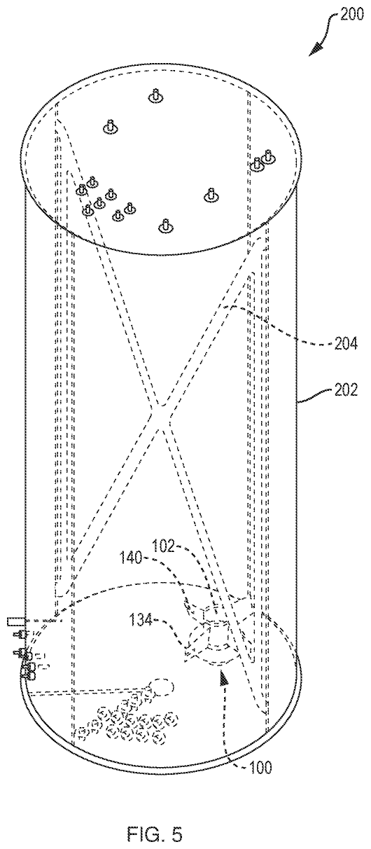

FIG. 5 depicts a side perspective view of a bioprocessing system 200 comprising a single use bioreactor bag 202 and a hollow shaft impeller 100 having impeller blades 134 that comprise fins 140, according to some embodiments of the disclosure. The bioprocessing system 200 further comprises a rotating shaft having a first end and a second end, the rotating shaft having a vertical rotational axis, as are known to those in the art. The bioreactor bag 202 may have an internal volume of 10 liters (L) to 10,000 L. In some embodiments, the bioreactor bag 202 further comprises a baffle 204, for enhanced mixing. Embodiments of the impellers disclosed herein comprise hollow shafts as well as fins on impeller blades. It is noted that particularly for bioreactors having internal volumes greater than 200 L, the hollow shaft impellers 100, with or without fins on the blades, are particularly effective.

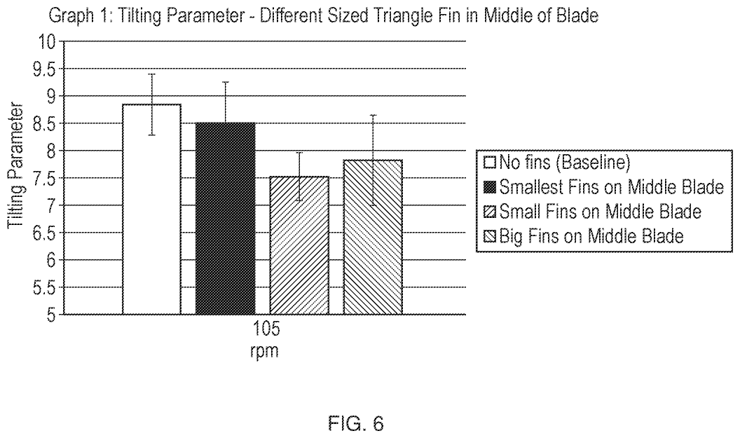

FIG. 6 illustrates a graph that depicts a tilting parameter of an impeller at 105 RPM, according to embodiments of the disclosure. The tilting parameter is a dimensionless number that quantifies the amount of tilt experienced from the impeller itself. To quantify the limit of tilting, the impeller is pushed down until the blade touches the tank or side of cup, which is considered the worst case or maximum tilting parameter. The data in the graph of FIG. 6 was generated from a 4-pitch hollow shaft impeller 100 having impeller blades 134, each of the blades 134 further comprising one fin 140 located in a middle of the impeller blades 134. As shown, three differently sized fins 140 were tested. The size of the impeller tested had a 16″ diameter and was placed within a 2000 L bioreactor bag 202 for some exemplary embodiments. The data in the graph of FIG. 6 represents the different amounts of impeller wobble experienced by hollow shaft impellers 100 with different sized fins 140. All three of the different sized fins 140 demonstrated an acceptable tilting parameter at the maximum, 105 RPM, and showed improvement from other impellers, including hollow shaft impellers, having no inclusion of fins for stabilizers. The smallest size of the fin 140 studied comprises a fin area of approximately 21.9 cm² or 3.4 in². A small fin that was studied comprises a fin area of approximately 41.3 cm² or 6.4 in². A big fin that was studied comprises a fin area of approximately 69.7 cm² or 10.8 in². The bars in the graph of FIG. 6, from left to right, are no fins, smallest fins disposed on the middle of blade, small fins disposed on the middle of blade, and big fins disposed on the middle of blade. As shown in the graph of FIG. 6, the small fins are particularly effective and produce the best improvement in impeller tilt/wobble.

All ranges for formulations recited herein include ranges therebetween and can be inclusive or exclusive of the endpoints. Optional included ranges are from integer values therebetween (or inclusive of one original endpoint), at the order of magnitude recited or the next smaller order of magnitude. For example, if the lower range value is 0.2, optional included endpoints can be 0.3, 0.4, . . . 1.1, 1.2, and the like, as well as 1, 2, 3 and the like, if the higher range is 8, optional included endpoints can be 7, 6, and the like, as well as 7.9, 7.8, and the like. One-sided boundaries, such as 3 or more, similarly include consistent boundaries (or ranges) starting at integer values at the recited order of magnitude or one lower. For example, 3 or more includes 4, or 3.1 or more.

Reference throughout this specification to “one embodiment,” “certain embodiments,” “one or more embodiments,” “some embodiments,” or “an embodiment” indicates that a feature, structure, material, or characteristic described in connection with the embodiment is included in at least one embodiment of the disclosure. Therefore, the appearances of the phrases such as “in one or more embodiments,” “in certain embodiments,” “in one embodiment,” “some embodiments,” or “in an embodiment” throughout this specification are not necessarily referring to the same embodiment.

Although some embodiments have been discussed above, other implementations and applications are also within the scope of the following claims. Although the specification describes, with reference to particular embodiments, it is to be understood that these embodiments are merely illustrative of the principles and applications of the present disclosure. It is therefore to be further understood that numerous modifications may be made to the illustrative embodiments and that other arrangements and patterns may be devised without departing from the spirit and scope of the embodiments according to the disclosure. Furthermore, particular features, structures, materials, or characteristics may be combined in any suitable manner in any one or more of the embodiments.

Publications of patent applications and patents and other non-patent references, cited in this specification are herein incorporated by reference in their entirety in the entire portion cited as if each individual publication or reference were specifically and individually indicated to be incorporated by reference herein as being fully set forth. Any patent application to which this application claims priority is also incorporated by reference herein in the manner described above for publications and references.

1. A hollow shaft impeller, comprising:
a hollow impeller housing having a hub defining an interior volume and an impeller bore providing access to the interior volume;
a magnet sized to be disposable within the interior volume;
an impeller cap removably coupled to the hollow impeller housing proximate to the impeller bore;
an impeller retainer removably coupled to the magnet and sized to be disposed within the interior volume; and
a plurality of impeller blades projecting from the hub.

2. The hollow shaft impeller of claim 1, wherein the plurality of impeller blades includes three, four, or five impeller blades.

3. The hollow shaft impeller of claim 1, further comprising at least one fin disposed on each impeller blade of the plurality of impeller blades.

4. The hollow shaft impeller of claim 3, wherein the at least one fin is triangular shaped.

5. The hollow shaft impeller of claim 3, wherein the at least one fin is disposed on each impeller blade of the plurality of impeller blades between a top edge and a bottom edge of each impeller blade of the plurality of impeller blades.

6. The hollow shaft impeller of claim 3, wherein the at least one fin is disposed on, and extends from, a blade face of each impeller blade of the plurality of impeller blades.

7. The hollow shaft impeller of claim 1, further comprising a gasket coupled to the impeller cap and configured to, with the impeller cap, seal the interior volume at the impeller bore.

8. The hollow shaft impeller of claim 7, wherein the gasket is an O-ring.

9. The hollow shaft impeller of claim 7, wherein the gasket comprises an elastomeric material.

10. The hollow shaft impeller of claim 9, wherein the elastomeric material is a vinyl material, a polyethylene material, a polypropylene material, a nylon material, a silicon material, a polytetrafluoroethylene material, or a rubber material.

11. The hollow shaft impeller of claim 1, wherein the impeller retainer comprises:
a circular flange having a top surface and an opposite bottom surface.

12. The hollow shaft impeller of claim 11, wherein the impeller retainer further comprises:
a boss projecting from the top surface of the circular flange.

13. The hollow shaft impeller of claim 12, wherein, when the impeller retainer is disposed within the interior volume, the boss is configured to interact with the impeller cap.

14. The hollow shaft impeller of claim 11, wherein the impeller retainer further comprises:
a cylinder descending from the bottom surface of the circular flange.

15. The hollow shaft impeller of claim 14, wherein the cylinder of the impeller retainer comprises:
a plurality of rails disposed about an exterior surface of the cylinder.

16. The hollow shaft impeller of claim 15, wherein the magnet comprises:
a bore centrally disposed on the magnet; and
a plurality of slots disposed around a perimeter of the bore.

17. The hollow shaft impeller of claim 16, wherein the cylinder and the plurality of rails are keyed to the bore and the plurality of slots of the magnet such that the bore and the plurality of slots of the magnet are configured to at least partially receive the cylinder and the plurality of rails of the impeller retainer.

18. The hollow shaft impeller of claim 17, wherein, when the cylinder and the plurality of rails of the impeller retainer are disposed within the bore and the plurality of slots of the magnet, the magnet is coupled to the impeller retainer.

19. The hollow shaft impeller of claim 1, wherein the impeller cap comprises:
cap beams and cap slots disposed about the impeller cap.

20. The hollow shaft impeller of claim 19, wherein the impeller bore of the hollow shaft impeller comprises:
hub beams and hub slots disposed about the impeller bore, wherein the cap beams are configured to be disposed within the hub slots and the hub beams are configured to be disposed within the cap slots when the impeller cap is coupled to the hollow impeller housing.
